(19) United States
(12) Patent Application Publication
(10) Pub. No.: US 2018/0010747 A1
(43) Pub. Date: Jan. 11, 2018

(54) SMART LAMP DEVICE

(71) Applicant: HABEMIT INTERNATIONAL CO. LTD., Taoyuan City (TW)

(72) Inventors: Chin-Wen WANG, Taoyuan City (TW); Tzu WANG, Taoyuan City (TW)

(21) Appl. No.: 15/206,874

(22) Filed: Jul. 11, 2016

(51) Int. Cl. F21S 8/08; F21V 21/30; F21V 31/03; F21V 23/02; F21V 21/116; F21V 15/01; H05B 33/08; F21V 31/00; F21W 131/103

(52) U.S. Cl. CPC F21S 8/086; H05B 33/0884; F21V 21/30; F21V 29/763; F21V 31/03; F21V 31/005; F21V 23/023; F21V 29/75; F21V 21/116; F21V 15/01; F21Y 2115/10; F21W 2131/103

(57) ABSTRACT

A smart lamp device applied to a remote host includes a lamp body, an LED module, a power supply module, a detector and a lamp frame assembly. The power supply module is contained in the lamp body and electrically connected to the LED module; the detector is installed to a lid of the lamp body and electrically connected to the LED module and the power supply module; the lamp frame assembly includes a first clamp, a second clamp and a hollow rod, and the hollow rod has a middle section and two extensions extended from both ends of the middle section, and the middle section is adjustably clamped between the first clamp and the second clamp, and the two extensions are fixed to both sides of the lamp body respectively.

### FIELD OF THE INVENTION

The technical field generally relates to lighting, more particularly to a smart lamp device.

### BACKGROUND OF THE INVENTION

Most traditional road lamps are installed at locations such as outdoor streets, roads, or squares. Since the outdoor environment has sunny, cloudy, rainy, snowy, foggy, or other climatic changes, therefore the road lamps have to bear with wind, sunshine, rain, and snow. However, the wind may shake and vibrate the road lamps; the sunshine may cause overheat of the road lamps, and the rain and snow may moisten or corrode the road lamps and cause short circuits or damage various electronic components in the road lamps. As a result, the road lamps usually require maintenance, repair, and replacement.

However, the aforementioned traditional road lamps are generally maintained, repaired or replaced by maintenance personnel based on their experience to try to replace the possible damaged electronic components one by one, or the set of the electronic component module is replaced directly by the maintenance personnel, so as to allow the road lamps to provide the illumination function again. Obviously, it takes a long time to maintain, repair, or replace the possible damaged electronic components one by one, and it incurs a high cost for maintaining, repairing, or replacing the whole set of electronic component module directly. The maintenance of the road lamps has the aforementioned issues.

In view of the aforementioned problems of the prior art, the discloser of this disclosure based on years of experience in the related industry to conduct extensive researches and experiments, and finally provided a feasible solution to overcome the problems of the prior art.

### SUMMARY OF THE INVENTION

It is a primary objective of this disclosure to provide a smart lamp device using a detector to detect the operating status of an LED module and a power supply module, so as to generate an electrical signal which is received by a remote host, so that maintenance personnel can determine whether related electronic components are normal or damaged and prevent spending too much time to test and replace the whole set of LED module or power supply module in order to achieve the effects of saving maintenance time and lowering maintenance cost.

To achieve the aforementioned and other objectives, this disclosure provides a smart lamp device applied to a remote host, and the smart lamp device comprises: a lamp body, further comprising a base and a lid coupled to one another; an LED module, installed to and exposed from the base; a power supply module, contained inside the lamp body and electrically coupled to the LED module; a detector, installed to the lid and electrically coupled to the LED module and the power supply module, for detecting the operating status of the LED module and the power supply module to generate an electrical signal which is received by the remote host; and a lamp frame assembly, comprising a first clamp, a second clamp and a hollow rod, and the hollow rod having a middle section and two extensions extended from both ends of the middle section respectively, and the middle section being adjustably clamped between the first clamp and the second clamp, and the two extensions being fixed to both sides of the base respectively.

### BRIEF DESCRIPTION OF THE DRAWINGS

FIG. 1 is an exploded view of a smart lamp device of this disclosure;

FIG. 2 is a partial exploded view of a smart lamp device of this disclosure;

FIG. 3 is another partial exploded view of a smart lamp device of this disclosure;

FIG. 4 is an exploded view of a lamp frame assembly of this disclosure;

FIG. 5 is a perspective view of a smart lamp device of this disclosure;

FIG. 6 is another perspective view of a smart lamp device of this disclosure;

FIG. 7 is a further perspective view of a smart lamp device of this disclosure;

FIG. 8 is a sectional view of a smart lamp device of this disclosure;

FIG. 9 is another sectional view of a smart lamp device of this disclosure;

FIG. 10 is a schematic view of a using status of a smart lamp device of this disclosure;

FIG. 11 is a schematic view of another using status of a smart lamp device of this disclosure; and

FIG. 12 is a schematic view of a further using status of a smart lamp device of this disclosure.

### DESCRIPTION OF THE PREFERRED EMBODIMENTS

The technical contents of this disclosure will become apparent with the detailed description of preferred embodiments accompanied with the illustration of related drawings as follows. It is intended that the embodiments and figures disclosed herein are to be considered illustrative rather than restrictive.

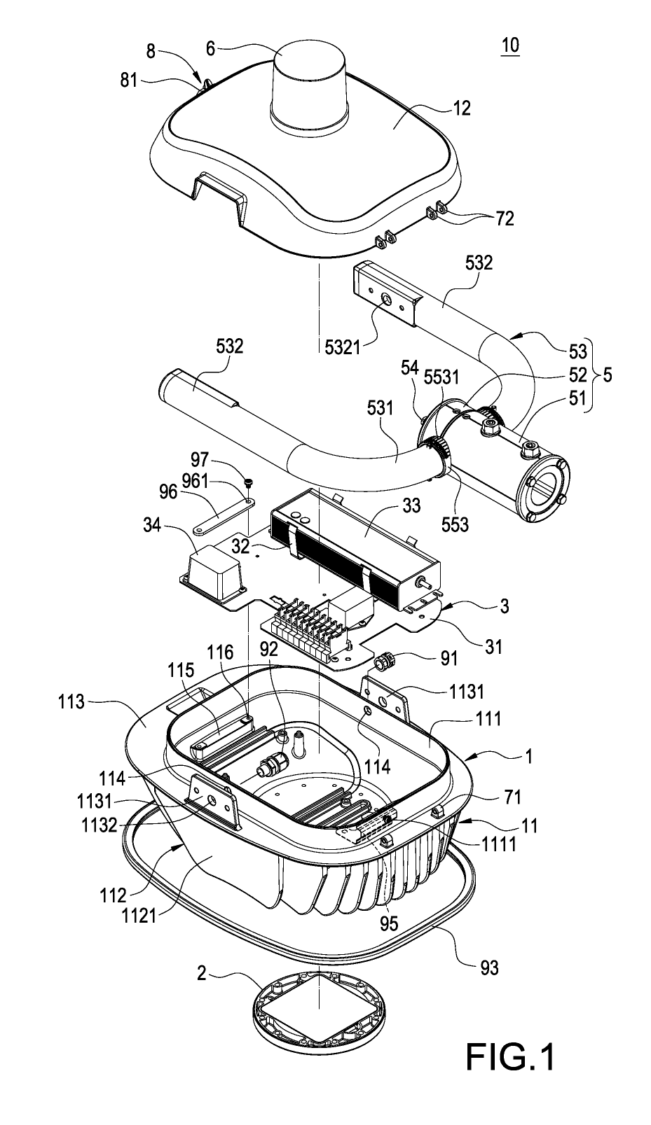

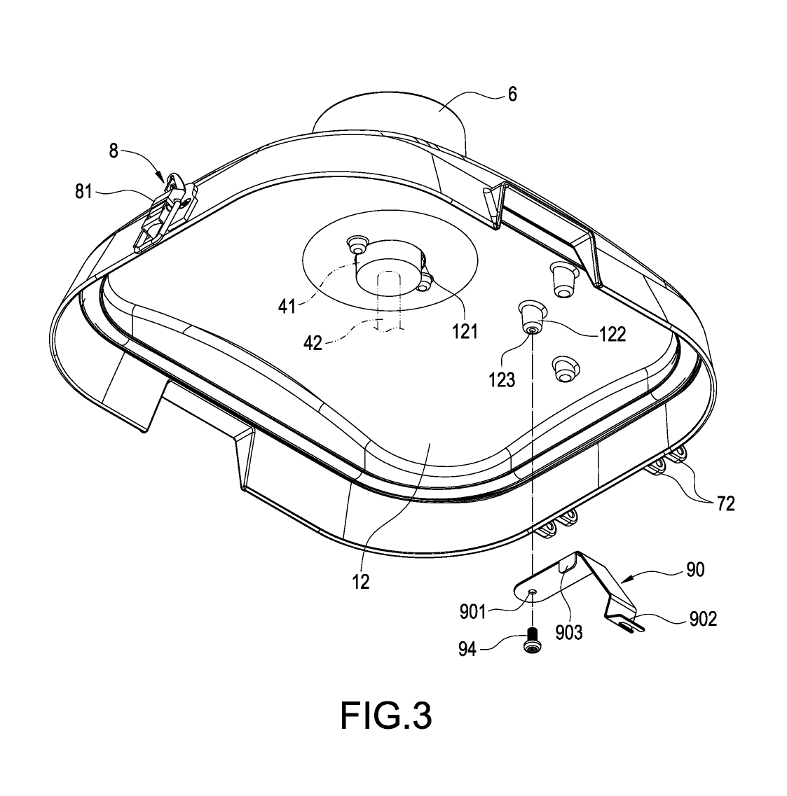

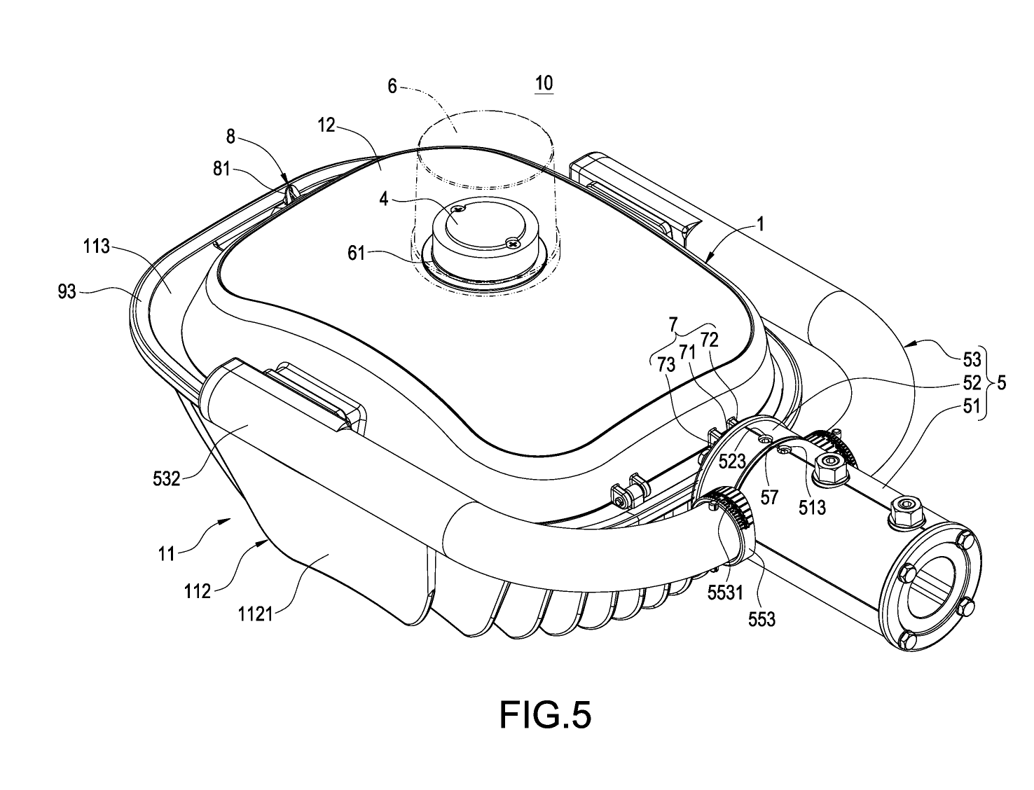

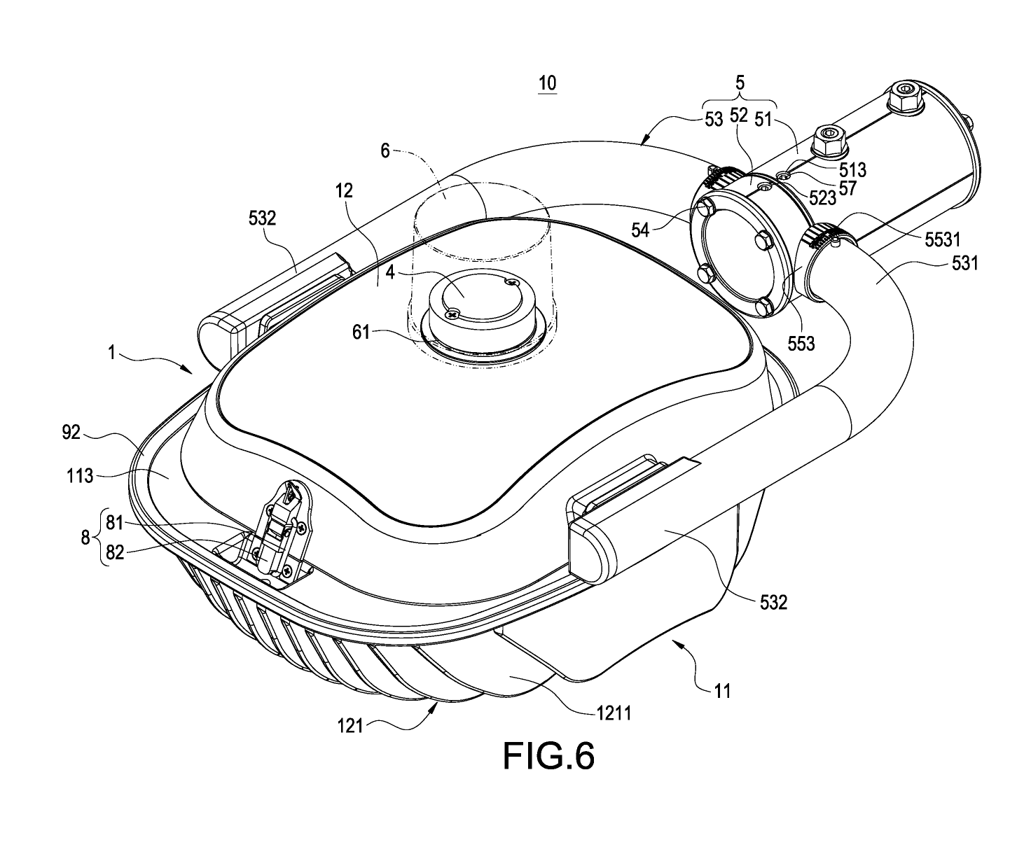

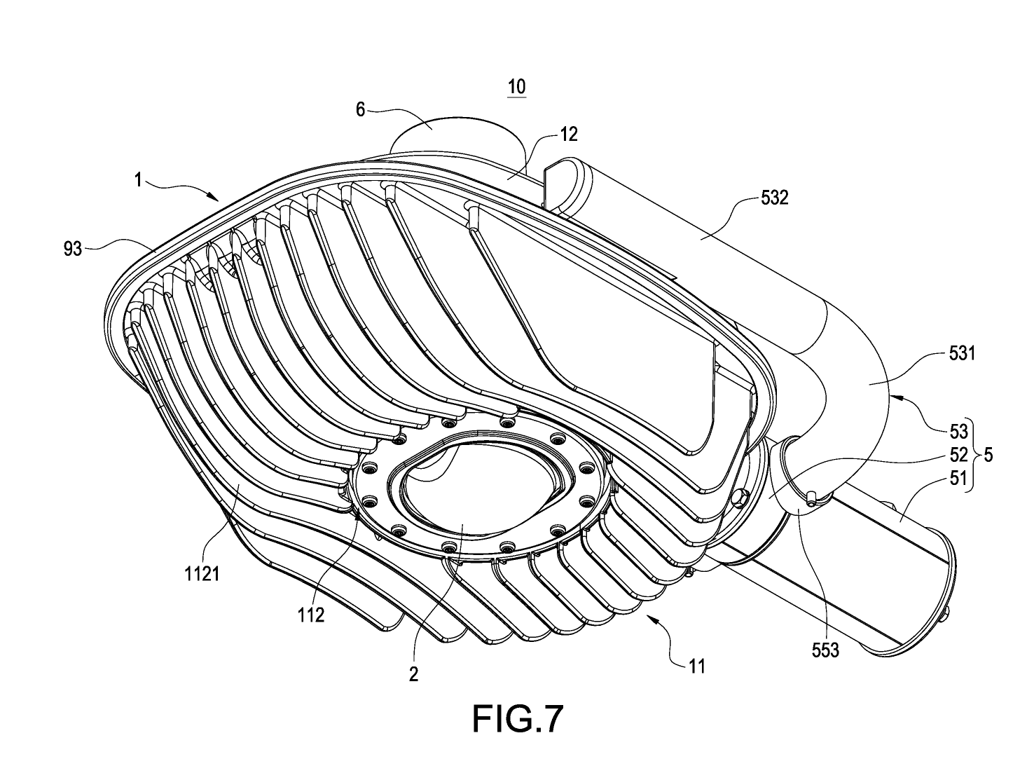

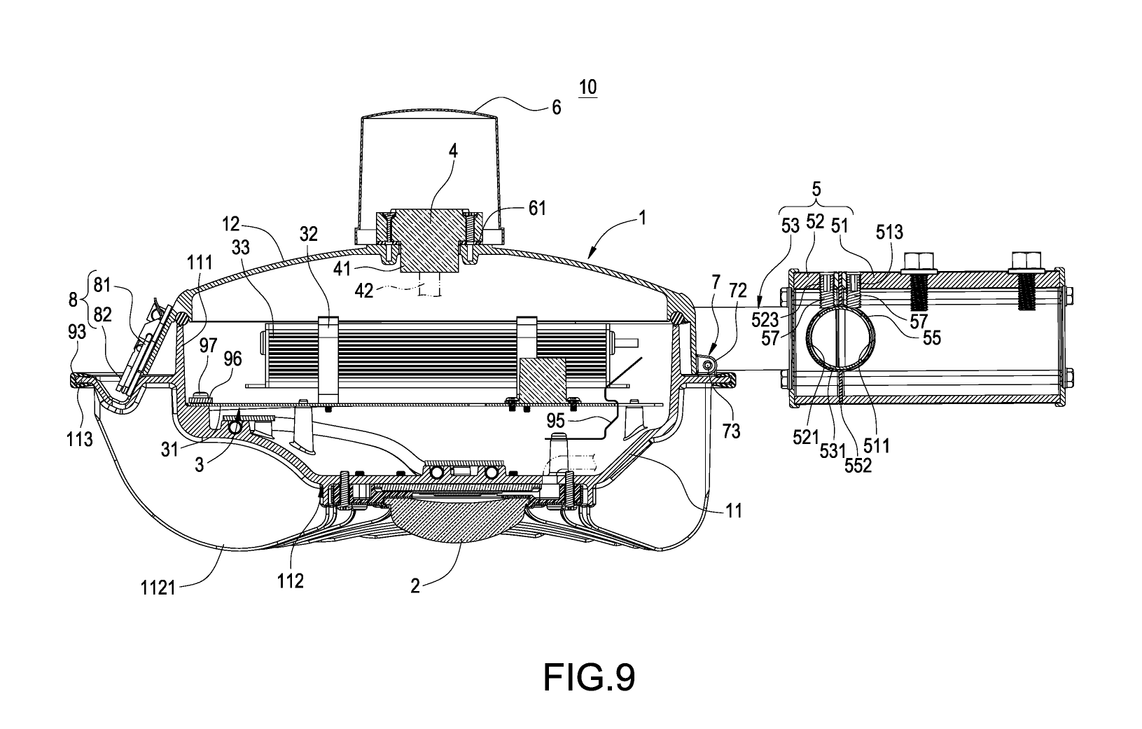

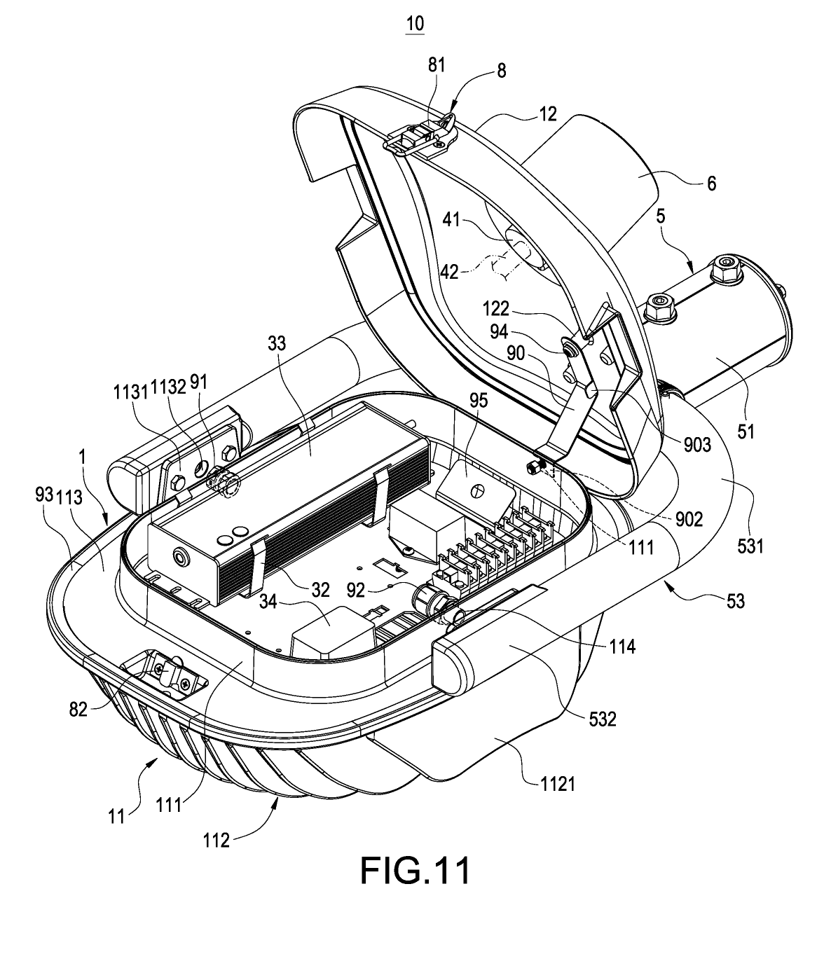

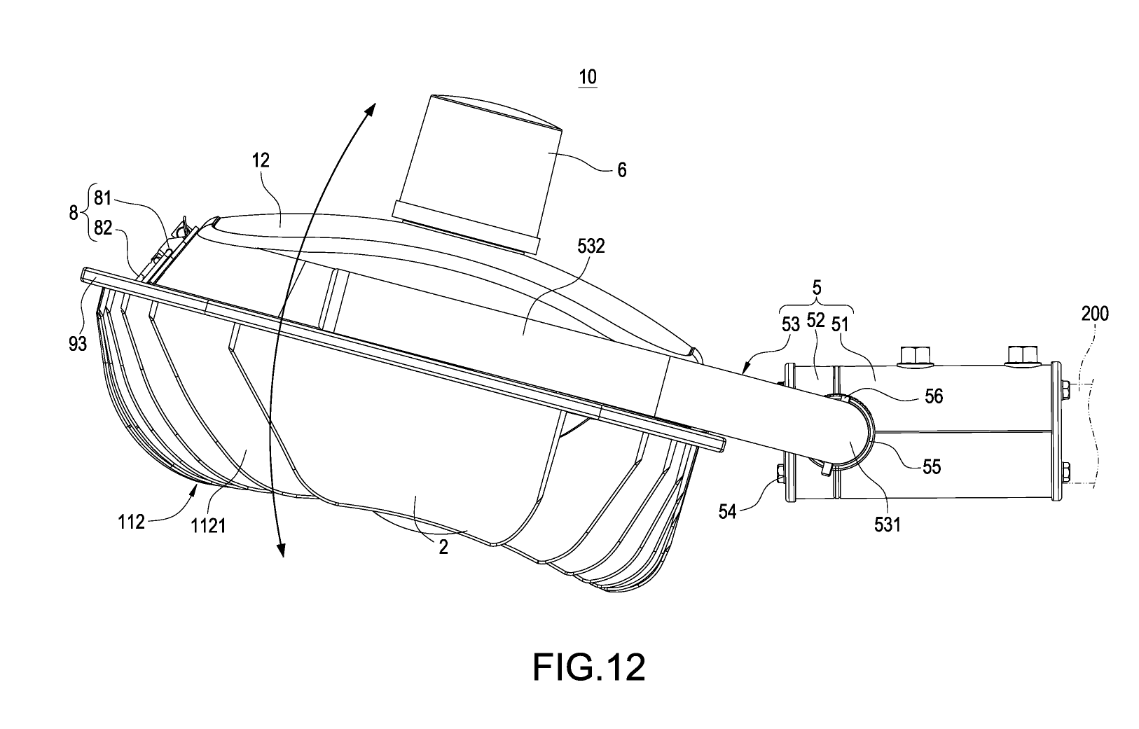

With reference to FIGS. 1 to 12 for a smart lamp device of this disclosure, the smart lamp device 10 comprises a lamp body 1, an LED module 2, a power supply module 3, a detector 4, and a lamp frame assembly 5.

The smart lamp device 10 is applied to a remote host (not shown in the figure), and the remote host (not shown in the figure) may be a desktop computer, a notebook computer, a flat PC, or a smart phone.

In FIGS. 1 to 3 and 5 to 9, the lamp body 1 comprises a base 11 and a lid 12 coupled to one another, and a circular wall 111 is extended from the top of the base 11 and a cooling portion 112 is disposed at the bottom of the base 11, and a plurality of fins 1121 is extended from the cooling portion 112.

In addition, a circular receiving plate 113 is formed between the external periphery of the base 11 and the circular wall 111, and two positioning plates 1131 are extended from both sides of the circular receiving plate 113 respectively, and each positioning plate 1131 has a first penetrating hole 1132, and the lid 12 covers the circular wall 111 and the two positioning plates 1131, and two second penetrating holes 114 are formed on both sides of the circular wall 111 respectively, and the circular wall 111 has a latch block 1111, and an abutting block 115 is extended from the interior of the base 11, and the abutting block 115 has a plurality of first passing holes 116.

In addition, a through slot 121 is formed at the top of the lid 12 and communicated with the interior of the lamp body 1, and a stud 122 is extended from the bottom of the lid 12 and has a pivot hole 123.

In FIGS. 1 and 7 to 9, the LED module 2 is installed to and exposed from the cooling portion 112 of the base 11, and the fins 1121 of the cooling portion 112 are provided for cooling the LED module 2.

In FIGS. 1, 8 and 9, the power supply module 3 is contained in the lamp body 1 and electrically coupled to the LED module 2, and the power supply module 3 comprises a circuit board 31, a U-shaped conductive latch 32, a power supply device 33, and a surge absorber 34, and the U-shaped latch 32 and the surge absorber 34 are fixed and electrically coupled to the circuit board 31, and the power supply device 33 is detachably latched to the U-shaped conductive latch 32. Wherein, the surge absorber 34 is provided for resisting lightening, and the U-shaped conductive latch 32 is provided for a quick connection or connection of the power supply device 33 facilitate installing/removing the power supply device 33 to/from the circuit board 31.

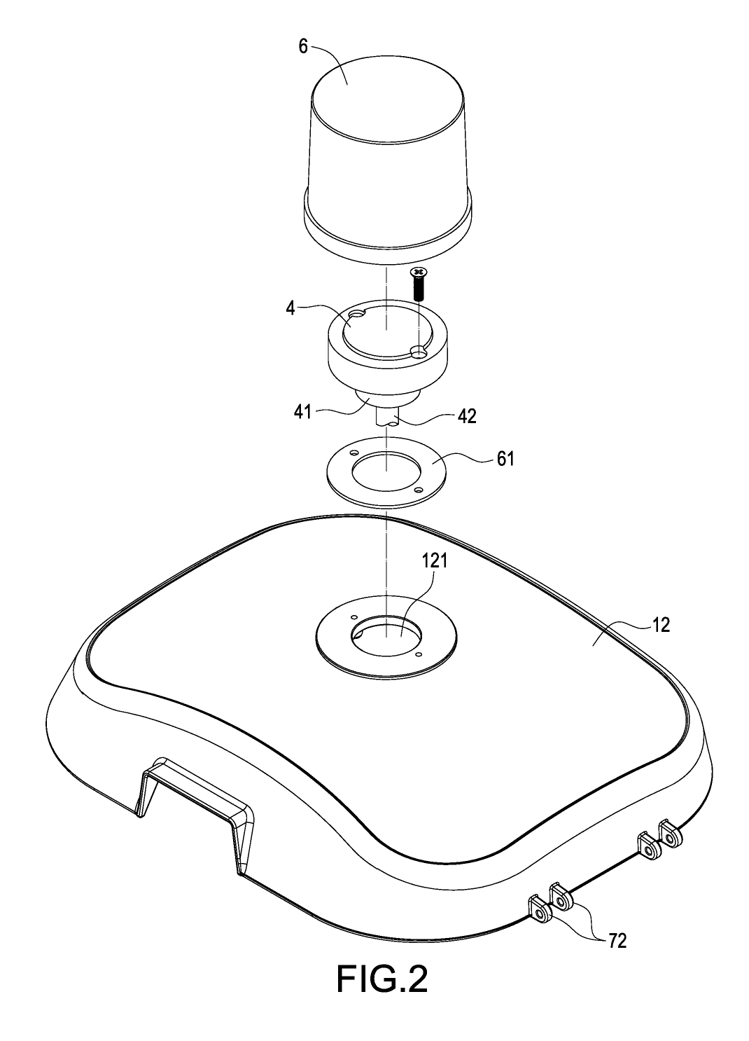

In FIGS. 2, 3, 5, 6, 8 and 9, the detector 4 is installed to the lid 12. Specifically, the detector 4 has a bump 41 extended from the detector 4 and at least one electric wire 42, and the detector 4 is locked to the lid 12, and the bump 41 is passed and latched to the through slot 121, and the electric wire 42 is passed through slot 121 and electrically coupled to the circuit board 31, so that the detector 4 is electrically coupled to the LED module 2 and the power supply module 3 through the through slot 121.

The detector 4 is fixed to the through slot 121 and electrically coupled to the LED module 2 and the power supply module 3 for detecting the operating status (such as a normal operation or a breakdown) of the LED module 2 and the power supply module 3 to generate an electrical signal which is received by a remote host (not shown in the figure). Wherein, the detector 4 has a plurality of electric wires 41 coupled to the circuit board 31.

In FIGS. 1, 4, and 5 to 9, the lamp frame assembly 5 comprises a first clamp 51, a second clamp 52, a hollow rod 53, a plurality of locking elements 54, an anti-slip sleeve 55, two pins 56 and two pressing screws 57, and a first recessed groove 511 and a plurality of first locking holes 512 are formed on a side of the first clamp 51, and a second recessed groove 521 and a plurality of second locking holes 522 are formed on a side of the second clamp 52, and the hollow rod 53 has a middle section 531 and two extensions 532 extended from both ends of the middle section 531 respectively, and the middle section 531 is clamped between an inner wall of the first recessed groove 511 and an inner wall of the second recessed groove 521, and the anti-slip sleeve 55 is clamped between the first clamp 51, the second clamp 52, and the middle section 531, wherein the anti-slip sleeve 55 is made of silicone or rubber to improve the friction between the first clamp 51, the second clamp 52 and the middle section 531.

Wherein, the first clamp 51 has a first screw hole 513 configured to be corresponsive to the anti-slip sleeve 55, and the second clamp 52 has a second screw hole 523 configured to be corresponsive to the anti-slip sleeve 55, and one of the pressing screws 57 is screwed and coupled to the first screw hole 513, and the other pressing screw 57 is screwed and coupled to the second screw hole 523, and the bottom of each pressing screw 57 is pressed against the anti-slip sleeve 55, and the pressing screw 57 is provided for pressing the anti-slip sleeve 55 to improve the friction between the first clamp 51, the second clamp 52 and the middle section 531 to forcibly fix the positions of the first clamp 51, the second clamp 52, the middle section 531, and the anti-slip sleeve 55.

In addition, the anti-slip sleeve 55 has a sunken groove 551 and two protruding plates 552, and the two protruding plates 552 are formed and extended from the top and bottom side of the bottom wall of the sunken groove 551, and each protruding plate 552 has a plurality of third locking holes 5521, and the first clamp 51 and the second clamp 52 are jointly embedded into the sunken groove 551, and the two protruding plates 552 are clamped between the first clamp 51 and the second clamp 52, and each locking element 54 is locked to each respective first locking hole 512, each respective second locking hole 522, and each respective third locking hole 5521, so that the middle section 531 can be adjustably clamped between the first clamp 51 and the second clamp 52.

In addition, the middle section 531 of this embodiment is substantially in a circular cylindrical shape, and the first recessed groove 511 and the second recessed groove 521 are substantially in a semi-circular shape, and the anti-slip sleeve 55 is substantially in a circular cylindrical shape, and each protruding plate 552 is substantially in a semi-circular shape, but the invention is not limited to such arrangement only. The middle section 531, the first recessed groove 511, the second recessed groove 521, the anti-slip sleeve 55 and the protruding plate 552 may be of any other geometric shape, too.

In addition, the two extensions 532 are locked to the two positioning plates 1131 respectively, so that the two extensions 532 are fixed to both sides of the base 11 respectively, and a third penetrating hole 5321 is formed on an inner side of each extension 532, and each respective second penetrating hole 114, each respective first penetrating hole 1132, and each respective third penetrating hole 5321 are configured with respective to one another.

In addition, the anti-slip sleeve 55 has two rim sections 553 formed on the left and right ends of the anti-slip sleeve 55 respectively, and the two rim sections 553 are exposed from the exterior of the first clamp 51 and the second clamp 52, and each rim section 553 has a calibration 5531, and two pins 56 are inserted into the middle section 531 and blocked and positioned at the outer sides of the two rim sections 553, so as to limit the position of the anti-slip sleeve 55 by the two pins 56.

In FIGS. 2, 5, and 6, the smart lamp device 10 of this disclosure further [symbol] a cover 6 and a waterproof gasket 61, and the cover 6 is fixed to the lid 12 and covers the detector 4, and the waterproof gasket 61 is clamped between the detector 4 and the lid 12, and the cover 6 and the two waterproof gaskets 61 are provided for protecting electronic components in the detector 4 and the smart lamp device 10 to prevent the electronic component inside the detector 4 and the smart lamp device 10 from being contaminated or moistened.

In FIGS. 1 to 3, 5, 6, and 9, an end of the circular receiving plate 113 proximate to a first clamp 51 and a second clamp 52 are pivotally coupled to the lid 12 by a hinge structure 7, and an end of the circular receiving plate 113 away from the first clamp 51 and the second clamp 52 is latched to the lid 12 by a buckle structure 8 to facilitate opening the lid 12 or covering the lid 12 onto the base 11.

Specifically, the hinge structure 7 comprises two first pivoting blocks 71, two second pivoting blocks 72, and two shafts 73, and the two first pivoting blocks 71 are formed and extended from the circular receiving plate 113, and the two second pivoting blocks 72 are formed and extended from the lid 12, and each shaft 73 is pivotally coupled to each respective first pivoting block 71 and each respective second pivoting block 72.

In addition, the buckle structure 8 comprises a turning buckle 81 and a buckle block 82, and the turning buckle 81 is fixed to the lid 12, and the buckle block 82 is fixed to the base 11, and the turning buckle 81 is detachably latched to the buckle block 82.

In FIGS. 1, 3, 8, 10, and 11, the smart lamp device 10 of this disclosure further comprises a latching plate 90 and a fixing column 94, and a through hole 901 is formed at an end of the latching plate 90 and a hook 902 is disposed at the other end of the latching plate 90, and a turning plate 903 is extended from the latching plate 90 and configured between the through hole 901 and the hook 902, and the fixing column 94 is passed and fixed into the pivot hole 123 and the through hole 901, so that when the turning plate 903 drives the latching plate 90 to move, the latching plate 90 can be turned by using the fixing column 94 as a center, and the hook 902 can be latched/separate to/from the latch block 1111. When the hook 902 and the latch block 1111 are latched with each other, the latching plate 90 can support the lid 12, so that the lid 12 can be opened with respect to the base 11. When the hook 902 and the latch block 1111 are separated from each other, the latching plate 90 does not support the lid 12, so that the lid 12 covers the base 11 correspondingly.

In FIGS. 1 and 8 to 11, the smart lamp device 10 of this disclosure further comprises a throttle valve 91, a wire casing 92 and a retaining ring 93, and the throttle valve 91 is plugged into one of the second penetrating holes 114, and the wire casing 92 is plugged into the other second penetrating hole 114, and the retaining ring 93 is sheathed on the external periphery of the circular receiving plate 113.

In addition, the smart lamp device 10 of this disclosure further comprises a throttle valve 91 plugged into one of the second penetrating holes 114, such when the temperature inside the lamp body 1 is too high and the high temperature causes an expansion of air, the throttle valve 91 will open the second penetrating hole 114, so that the air pressure in the lamp body 1 will be released to the external environment, and the throttle valve 91 has the effect of adjusting the balance of the internal and external pressures of the lamp body 1.

In addition, the smart lamp device 10 of this disclosure further comprises a wire casing 92 plugged into another second penetrating hole 114. Since each respective second penetrating hole 114, each respective first penetrating hole 1132, and each respective third penetrating hole 5321 are configured to be corresponsive to one another, therefore the electric wires 100 inside the lamp body 1 can be guided by the wire casing 92 and passed into the second penetrating hole 114, the first penetrating hole 1132, and the third penetrating hole 5321 into the hollow rod 53 sequentially.

In addition, the smart lamp device 10 of this disclosure further comprises a retaining ring 93 sheathed on the external periphery of the circular receiving plate 113 to enhance the structure strength of the circular receiving plate 113.

In addition, the smart lamp device 10 of this disclosure further comprises an engaging plate 95, a pressing board 96 and a plurality of screws 97, and the engaging plate 95 is fixed into the base 11, and the pressing board 96 has a plurality of second passing holes 961, and each screw 97 is passed and fixed to each respective first passing hole 116 and each respective second passing hole 961, so that a side of the circuit board 31 is clamped between the abutting block 115 and the pressing board 96 and the other side of the circuit board 31 is latched to the engaging plate 95. Therefore, the engaging plate 95 and the pressing board 96 can be used for a quick connection or disconnection with the circuit board 31 to facilitate installing/removing the circuit board 31 to/from the base 11 quickly.

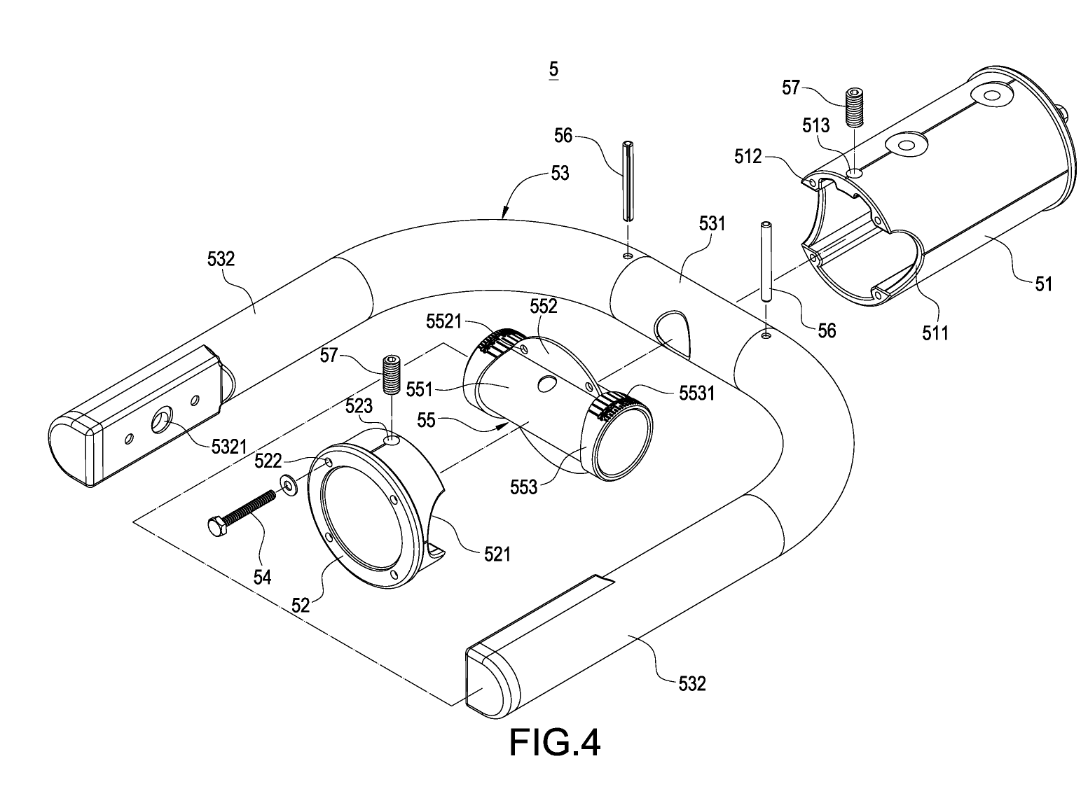

With reference to FIGS. 4 to 12 for the assembled and using statuses of the smart lamp device 10 of this disclosure, the lamp body 1 comprises a base 11 and a lid 12 coupled to each other; the LED module 2 is installed to and exposed from the base 11; the power supply module 3 is contained in the lamp body 1 and electrically coupled to the LED module 2; the detector 4 is installed to the lid 12, and the detector 4 is electrically coupled to the LED module 2 and the power supply module 3, and the detector 4 is provided for detecting the operating status of the LED module 2 and the power supply module 3 to generate an electrical signal which is received by a remote host (not shown in the figure); the lamp frame assembly 5 comprises a first clamp 51, a second clamp 52 and a hollow rod 53, and the hollow rod 53 has a middle section 531 and two extensions 532 extended from both ends of the middle section 531 respectively, and the middle section 531 is adjustably clamped between the first clamp 51 and the second clamp 52, and the two extensions 532 are fixed to both sides of the base 11 respectively. After a remote host (not shown in the figure) receives the electrical signal, maintenance personnel can determine whether or not the electronic components works normally or broke down through the remote host (not shown in the figure), so as to avoid expending too much time to test and replace the whole LED module 2 or power supply module 3 and achieve the effects of saving maintenance time and lowering maintenance cost.

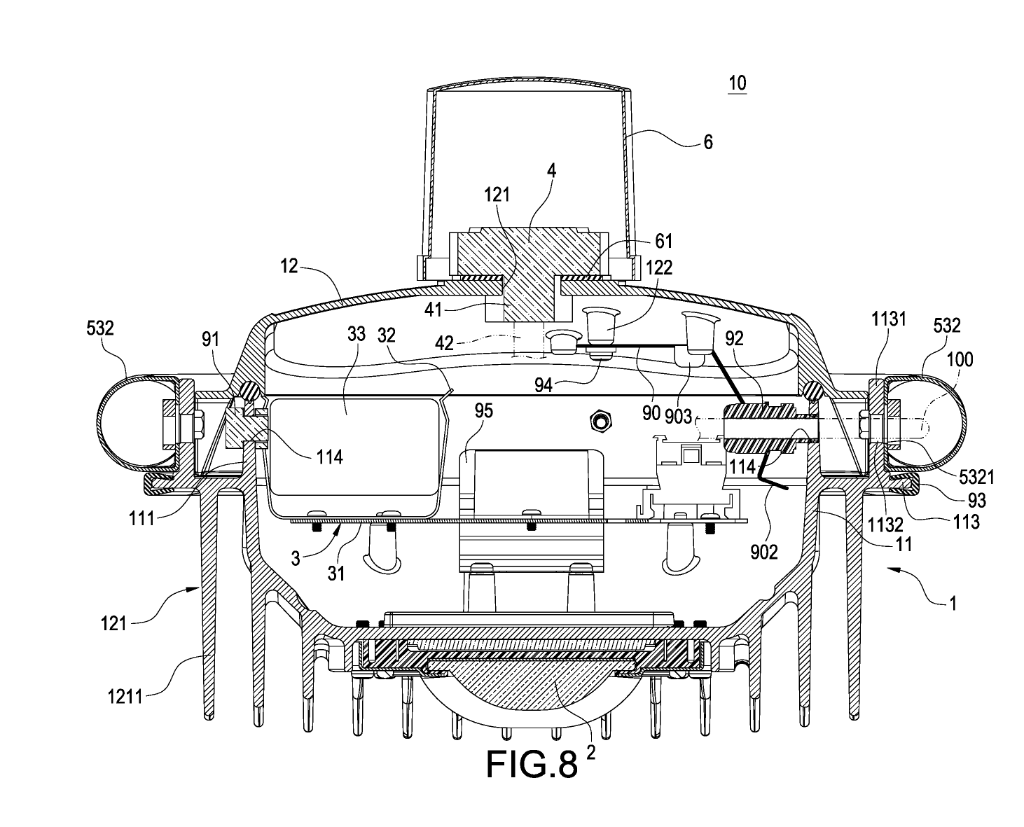

In FIGS. 8 to 12, the first clamp 51 and the lamp post 200 are fixed to each other, and the middle section 531 of the hollow rod 53 is clamped between an inner wall of the first recessed groove 511 and an inner wall of the second recessed groove 521, and each locking element 54 is locked to each respective first locking hole 512, each respective second locking hole 522, and each respective third locking hole 5521, so that when each locking element 54 is loosened, the angle of elevation of the hollow rod 53 with respect to the first clamp 51 can be adjusted, and the angle of elevation of the lamp body 1 with respect to the lamp post 200 can be adjusted. Therefore, the smart lamp device 10 has the feature of adjusting the illumination angle.

In addition, the angle of elevation of the lamp body 1 with respect to the lamp post 200 can be adjusted according to a calibration 5531 formed on the rim section 553, so that the smart lamp device 10 is capable of making a precise adjustment of the illumination angle.

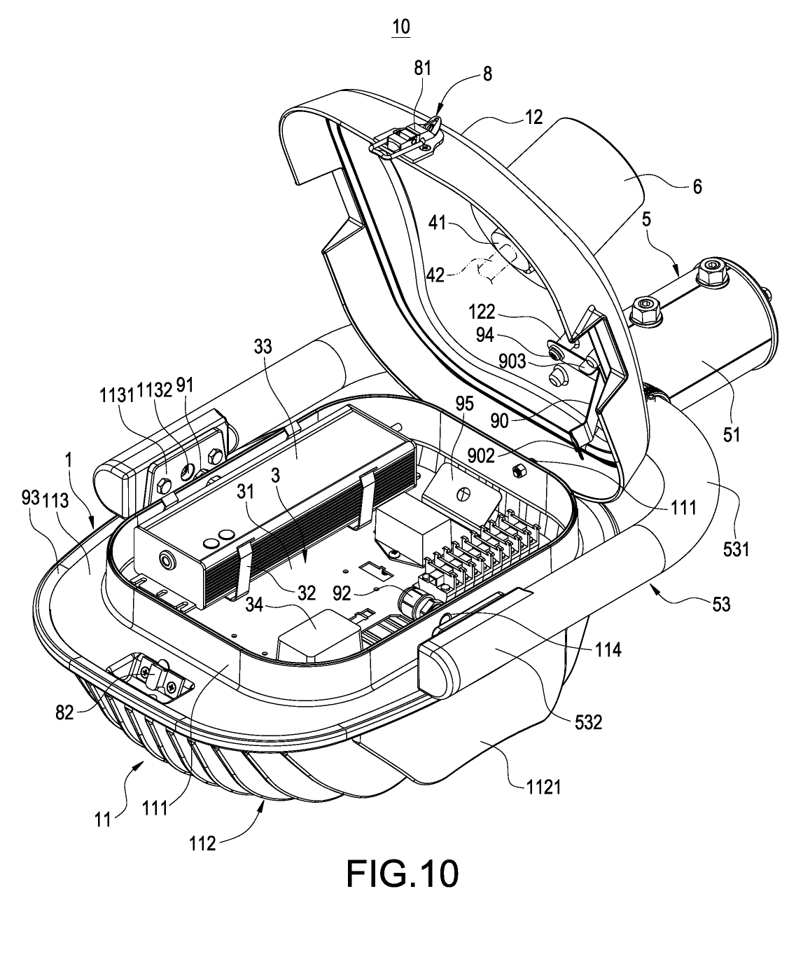

If the conventional road lamps are installed in a snowy environment, icicles may be formed at the road lamps, and an ice cone will be formed on the road lamps after the snow accumulated at the road lamps is melted, and the illumination is affected adversely. On the other hand, the smart lamp device 10 of this disclosure has an outwardly protruding circular receiving plate 113, and the smart lamp device 10 must be tilted to an angle of elevation when use as shown in FIG. 10, so that if snow is accumulated on the titled circular receiving plate 113, the gravitational force of the snow and the tilted surface of the circular receiving plate 113 will guide the accumulated snow to fall along the circular receiving plate 113 to the ground, so that the smart lamp device 10 has the advantage of preventing icicles (or an ice cone phenomenon).

While this disclosure has been described by means of specific embodiments, numerous modifications and variations could be made thereto by those skilled in the art without departing from the scope and spirit of this disclosure set forth in the claims.

What is claimed is:

1. A smart lamp device, applied to a remote host, comprising: a lamp body, further comprising a base and a lid coupled to one another; an LED module, installed to and exposed from the base; a power supply module, contained inside the lamp body and electrically coupled to the LED module;
a detector, installed to the lid, and electrically coupled to the LED module and the power supply module, for detecting the operating status of the LED module and the power supply module to generate an electrical signal which is received by the remote host; and a lamp frame assembly, comprising a first clamp, a second clamp and a hollow rod, and the hollow rod having a middle section and two extensions extended from both ends of the middle section respectively, and the middle section being adjustably clamped between the first clamp and the second clamp, and the two extensions being fixed to both sides of the base respectively.

2. The smart lamp device according to claim 1, further comprising: a cover and a waterproof gasket, and a through slot being formed at the top of the lid and communicated with the interior of the lamp body, and a bump being extended from the detector, and the detector being locked to the lid, and the bump being passed and latched into the through slot, and the detector being electrically coupled to the LED module and the power supply module through the through slot, and the cover being fixed to the lid and covering the detector, and the waterproof gasket being clamped between the detector and the lid, and the power supply module comprising a circuit board, and the detector having at least one electric wire passing through the through slot and being electrically coupled to the circuit board.

3. The smart lamp device according to claim 1, wherein the lamp frame assembly further comprising a plurality of locking elements and an anti-slip sleeve, and a first recessed groove and a plurality of first locking holes being formed on a side of the first clamp, and a second recessed groove and plurality of second locking holes being formed on a side of the second clamp, and the middle section being clamped between an inner wall of the first recessed groove and an inner wall of the second recessed groove, and each locking element being locked into each respective first locking hole and each respective second locking hole, and the anti-slip sleeve being clamped between the first clamp, the second clamp and the middle section.

4. The smart lamp device according to claim 3, wherein the anti-slip sleeve comprises a sunken groove and has two protruding plates and two rim sections, and the two protruding plates are formed and extended from the top and bottom sides of the sunken groove respectively, and each protruding plate has a plurality of third locking holes, and the two rim sections are formed at the left and right ends of the anti-slip sleeve respectively, and each rim section has a calibration, and the first clamp and the second clamp are jointly embedded into the sunken groove, and the two protruding plates are clamped between the first clamp and the second clamp, and each locking element is passed and installed into each third locking hole, and the two rim sections are exposed from the exterior of the first clamp and the second clamp, and the lamp frame assembly further comprises two pins and two pressing screws, and the two pins are inserted into the middle section and blocked and positioned by the outer sides of the two rim sections, and the first clamp has a first screw hole configured to be corresponsive to the anti-slip sleeve, and the second clamp has a second screw hole configured to be corresponsive to the anti-slip sleeve, and the two pressing screws are screwed and coupled to the first screw hole and the second screw hole respectively, and the bottom of each pressing screw is pressed against the anti-slip sleeve.

5. The smart lamp device according to claim 1, further comprising a throttle valve, a wire casing and a retaining ring, the base having a circular wall extended from the top of the base and a cooling portion disposed at the bottom of the base, and a circular receiving plate being formed between the external periphery of the base and the circular wall, and a plurality of fins being extended from the cooling portion, and the lid covering the circular wall, and the LED module being installed to the cooling portion, and two positioning plates being extended from both sides of the circular receiving plate respectively, and the two extensions being locked to the two positioning plates respectively, and each positioning plate having a first penetrating hole, and the circular wall having second penetrating hole formed on both sides of the circular wall, and each extension has a third penetrating hole formed on an inner side of the extension, and each first penetrating hole, each second penetrating hole, and each third penetrating hole being configured corresponsive to one another, and the lid covering the two positioning plates, and the throttle valve being plugged into one of the second penetrating holes, and the wire casing being plugged into the other second penetrating hole, and the retaining ring being sheathed on the external periphery of the circular receiving plate.

6. The smart lamp device according to claim 1, wherein the base has a circular wall extended from the top of the base and a cooling portion disposed at the bottom of the circular wall, and a circular receiving plate is formed between the external periphery of the base and the circular wall, and the cooling portion has a plurality of fins extended the cooling portion, and the lid covers the circular wall, and the LED module is installed to the cooling portion, and the circular receiving plate is pivotally coupled to an end proximate to the first clamp and the first and second clamps and the lid by a hinge structure, and the circular receiving plate is latched to an end away from the first clamp and the first and second clamps and the lid by a buckle structure, and the hinge structure includes two first pivoting blocks, two second pivoting blocks and two shafts, and the two first pivoting blocks are formed and extended from the circular receiving plate, and the two second pivoting blocks are formed and extended from the lid, and each shaft is pivotally coupled to each respective first pivoting block and each respective second pivoting block, and the buckle structure includes a turning buckle and a buckle block, and the turning buckle is fixed to the lid, and the buckle block is fixed to the base, and the turning buckle is detachably latched to the buckle block.

7. The smart lamp device according to claim 1, wherein the power supply module includes a circuit board, a U-shaped conductive latch, a power supply device, a surge absorber, and the U-shaped latch and the surge absorber are fixed and electrically coupled to the circuit board, and the power supply device is detachably latched to the U-shaped conductive latch.

8. The smart lamp device according to claim 1, further comprising a latching plate and a fixing column, and the circular wall has a latch block, and a stud is extended from the bottom of the lid and has a pivot hole, and a through hole is formed at an end of the latching plate and a hook is disposed at the other end of the latching plate, and the latching plate has a turning plate extended from the latching plate and configured between the through hole and the hook, and the fixing column is passed and fixed to the pivot hole and the through hole, so that the latching plate can be turned by using the fixing column as a center, and the hook can be latched to or separated from the latch block.

9. The smart lamp device according to claim 1, further comprising an engaging plate, a pressing board and a plurality of screws, and an abutting block being extended from the interior of the base and having a plurality of first passing holes, and the power supply module including a circuit board, and the engaging plate being fixed into the interior of the base, and the pressing board having a plurality of second passing holes, and each screw being passed and fixed to each respective first passing hole and each respective second passing hole, and a side of the circuit board being clamped between the abutting block and the pressing board, and the other side of the circuit board being latched to the engaging plate.
